(19) United States
(12) Patent Application Publication
(10) Pub. No.: US 2011/0043637 A1
(43) Pub. Date: Feb. 24, 2011

(54) IMAGE PICKUP DEVICE

(75) Inventor: Chen-Ping Yang, Taipei City (TW)

Correspondence Address: WPAT, PC;INTELLECTUAL PROPERTY ATTORNEYS, 2030 MAIN STREET, SUITE 1300, IRVINE, CA, 92614, US

(73) Assignee: DIGILIFE TECHNOLOGIES CO., LTD., Taipei City (TW)

(21) Appl. No.: 12/543,651

(22) Filed: Aug. 19, 2009

(51) Int. Cl. H04N 5/33; H04N 5/335

(52) U.S. Cl. 348/164; 348/294; 348/E05.09; 348/E05.091

(57) ABSTRACT

An image pickup device includes a main body, an image pickup assembly, and a cover. The image pickup assembly is located in the main body and has an image pickup section and an infrared emitter section. The image pickup section has a lens, a light filter, and a light sensing element. The light filter is located between the lens and the light sensing element to allow visible light and infrared light of a predetermined wavelength to pass therethrough and reach at the light sensing element. The cover is located on the main body to cover the image pickup assembly, and has an image pickup window positioned corresponding to the image pickup section and an emission window positioned corresponding to the infrared emitter section. With these arrangements, the image pickup device can be used to pick up images of an object in a fully dark environment.

### FIELD OF THE INVENTION

The present invention relates to an image pickup device, and more particularly to an image pickup device that can be used in an environment without light to pick up images of objects.

### BACKGROUND OF THE INVENTION

With the progress in the technological fields and the upgraded living standard among people, various kinds of portable electronic devices have been widely developed for use. Among others, digital image pickup devices, such as digital cameras, digital video cameras and the like, are most frequently used by people. Generally, when the digital image pickup device is used in an environment with sufficient light, object images can be very easily picked up. And, when the digital image pickup device is used in an environment with insufficient light, an auxiliary light source equipped with the device, such as a built-in flash on a digital camera and an auxiliary light source on the video camera, can still help a user to pick up object images in the dim environment. However, the conventional digital image pickup devices could not be used in a completely dark environment without any light to pick up any image.

It is therefore desirable and tried by the inventor to develop an image pickup device that can be used to pick up images in a fully dark environment.

### SUMMARY OF THE INVENTION

A primary object of the present invention is to provide an image pickup device equipped with a light filter and an infrared emitter section, so that infrared light of a predetermined wavelength can pass through the light filter, enabling the image pickup device to pick up images of objects in a fully dark environment.

To achieve the above and other objects, the image pickup device according to the present invention includes a main body, an image pickup assembly, and a cover. The image pickup assembly is located in the main body and has an image pickup section and an infrared emitter section. The image pickup section has a lens, a light filter, and a light sensing element. The light filter is located between the lens and the light sensing element to allow visible light and infrared light of a predetermined wavelength to pass therethrough and reach at the light sensing element behind the light filter. The cover is located on the main body to cover the image pickup assembly, and has an image pickup window positioned corresponding to the image pickup section and an emission window positioned corresponding to the infrared emitter section.

The predetermined wavelength of the infrared light is 850 nm.

The main body can be a main body of a digital camera or a main body of a digital video camera.

The light sensing element can be a complementary metal oxide semiconductor (CMOS) or a charge coupled device (CCD).

With these arrangements, the image pickup device can be used to shoot images of objects in a fully dark environment.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of an image pickup device according to a first preferred embodiment of the present invention;

FIG. 2 is an assembled view of FIG. 1;

FIG. 3 is a schematic view showing a light sensing element adopted in the image pickup device of the present invention;

FIG. 4 is a graph showing light signals passing through a light filter in the image pickup device of the present invention; and

FIG. 5 is a perspective view of an image pickup device according to a second preferred embodiment of the present invention.

### DETAILED DESCRIPTION OF THE PREFERRED EMBODIMENTS

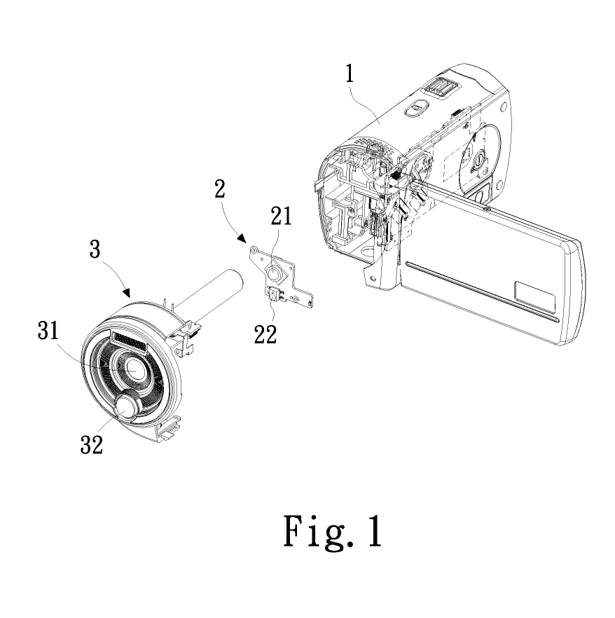

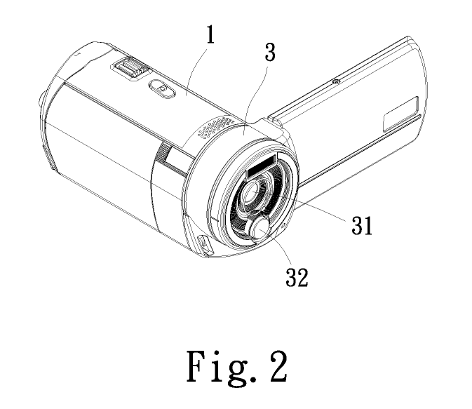

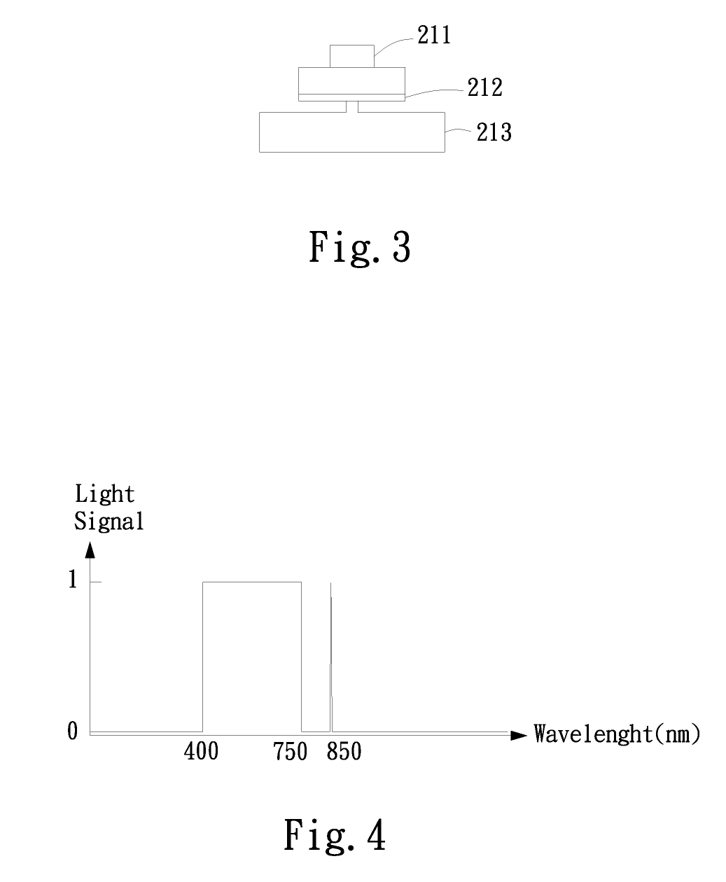

Please refer to FIGS. 1 and 2 that are exploded and assembled perspective views, respectively, of an image pickup device according to a first preferred embodiment of the present invention, and to FIG. 3 that is a schematic view showing a light sensing element adopted in the image pickup device of the present invention. As shown, the image pickup device of the present invention includes a main body 1, an image pickup assembly 2, and a cover 3. In the illustrated first preferred embodiment, the main body 1 is a main body for a digital video camera. The image pickup assembly 2 is located in the main body 1, and includes an image pickup section 21 and an infrared emitter section 22. The image pickup section 21 has a lens 211, a light filter 212, and a light sensing element 213. The light filter 212 is located between the lens 211 and the light sensing element 213. When the image pickup device is used in an environment with light, the light filter 212 allows a visible light to pass therethrough to the light sensing element 213; and when the image pickup device is used in an environment without any light, the light filter allows an infrared ray of a predetermined wavelength to pass therethrough to the light sensing element 213. The cover 3 is located on the main body 1 to cover the image pickup assembly 2, and has an image pickup window 31 and an emission window 32. The image pickup window 31 is positioned corresponding to the image pickup section 21, and the emitter window 32 is positioned corresponding to the infrared emitter section 22.

The infrared ray of a predetermined wavelength can be an infrared ray having a wavelength of 850 nm. Depending on different environments in which the image pickup device of the present invention is used, the infrared ray can also have a wavelength of 760 nm or 950 nm.

The light sensing element 213 can be a complementary metal oxide semiconductor (CMOS) or a charge coupled device (CCD), and has very small volume and quick response, and can therefore be advantageously used in the image pickup device of the present invention to enable reduced overall volume and shorten focusing time. The CMOS or CCD forming the light sensing element 213 also functions to digitalize picked images to facilitate subsequent image processing.

Generally speaking, light having a wavelength ranged between 200 nm and 400 nm is in the ultraviolet region, light having a wavelength ranged between 400 nm and 750 nm is in the visible light region, and light having wavelength ranged between 750 nm and 4000 nm is in the infrared region. FIG. 4 is a graph showing light signals passing through the light filter 212 in the image pickup device of the present invention. As shown, the light filter 212 used in the present invention allows visible light having wavelength ranged between 400 nm and 750 nm and infrared light having wavelength of 850 nm to pass therethrough. Please also refer to FIGS. 1 to 3. When the image pickup device of the present invention is used in an environment having light to pick up images of an object (not shown), visible light having wavelength ranged between 400 nm and 750 nm is reflected from the object to pass through the image pickup window 31 and the lens 211, and then passes through the light filter 212 to reach at the light sensing element 213. Thereafter, the light sensing element 213 digitalizes the picked images, and the digitalized images are sent to the main body 1 for subsequent processing. On the other hand, when the image pickup device of the present invention is used in a fully dark environment without any light to pick up images of an object (not shown), the infrared emitter section 22 first emits infrared ray having wavelength ranged between 750 nm and 4000 nm, which passes through the emission window 32 to irradiate the object to be shot and is reflected from the object. The reflected infrared light passes through the image pickup window 31 and the lens 211, and infrared light having wavelength of 850 nm is allowed to pass through the light filter 212 to reach at the light sensing element 213. Then, the light sensing element 213 digitalizes the picked images of the object and sends the digitalized images to the main body 1 for subsequent processing.

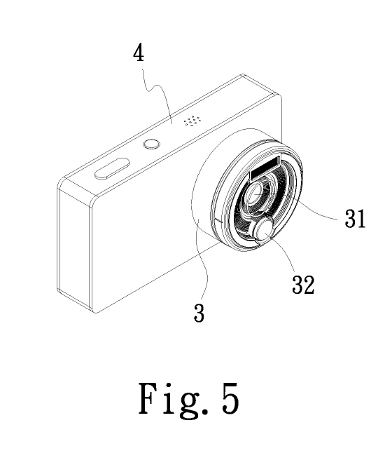

FIG. 5 is a perspective view showing an image pickup device according to a second preferred embodiment of the present invention. In the second preferred embodiment, the image pickup device has a main body 4 which is a main body for a digital camera. The image pickup device of the second preferred embodiment works in environments with light and without light in the same working principle as that for the first preferred embodiment.

In the present invention, the provision of the light filter and the infrared emitter section in the image pickup device allows infrared having a predetermined wavelength to pass through the light filter, so that the image pickup device can be used in a fully dark environment without any light to pick up images of an object. Any products derived from the present invention would obviously satisfy the market demands. Therefore, the present invention is novel, improved, and industrially practical for use to fully meet the requirements for granting a patent thereto.

The present invention has been described with some preferred embodiments thereof and it is understood that many changes and modifications in the described embodiments can be carried out without departing from the scope and the spirit of the invention that is intended to be limited only by the appended claims.

What is claimed is:

1. An image pickup device, comprising:
a main body;
an image pickup assembly being located in the main body and including an image pickup section and an infrared emitter section; the image pickup section having a lens, a light filter, and a light sensing element; the light filter being located between the lens and the light sensing element, and allowing visible light and infrared light of a predetermined wavelength to pass therethrough and reach at the light sensing element; and
a cover being located on the main body to cover the image pickup assembly; the cover having an image pickup window and an emission window, the image pickup window being positioned corresponding to the image pickup section, and the emission window being positioned corresponding to the infrared emitter section.

2. The image pickup device as claimed in claim 1, wherein the predetermined wavelength of the infrared light is 850 nm.

3. The image pickup device as claimed in claim 1, wherein the main body is selected from the group consisting of a digital camera main body and a digital video camera main body.

4. The image pickup device as claimed in claim 2, wherein the main body is selected from the group consisting of a digital camera main body and a digital video camera main body.

5. The image pickup device as claimed in claim 1, wherein the light sensing element is selected from the group consisting of a complementary metal oxide semiconductor (CMOS) and a charge coupled device (CCD).

6. The image pickup device as claimed in claim 2, wherein the light sensing element is selected from the group consisting of a CMOS and a CCD.

7. The image pickup device as claimed in claim 3, wherein the light sensing element is selected from the group consisting of a CMOS and a CCD.

8. The image pickup device as claimed in claim 4, wherein the light sensing element is selected from the group consisting of a CMOS and a CCD.
